(19) United States
(12) Patent Application Publication
(10) Pub. No.: US 2025/0370889 A1
(43) Pub. Date: Dec. 4, 2025

(54) SYSTEM AND METHOD FOR MAINTAINING TASK OPERATION CONTINUITY

(71) Applicant: ASRock Industrial Computer Corporation, Taipei City (TW)

(72) Inventors: Syuan-Jie Huang, Taipei City (TW); Kun-Chung Wu, Taipei City (TW)

(73) Assignee: ASRock Industrial Computer Corporation, Taipei City (TW)

(21) Appl. No.: 19/084,093

(22) Filed: Mar. 19, 2025

(30) Foreign Application Priority Data
May 28, 2024 (TW) 113119673

(51) Int. Cl. G06F 11/20

(52) U.S. Cl. CPC G06F 11/2033; G06F 11/2025; G06F 11/2064

(57) ABSTRACT

Provided are a system and a method for maintaining task operation continuity. The system includes a server that communicatively coupled to a first computer device and a second computer device. The server is configured to monitor an operating status of each of the first computer device and the second computer device, in which each of the first computer device and the second computer device is at least deployed with a first task on Docker, and the first task is assigned to be run by the first computer device, and in response to determining that the first computer device cannot operate normally, assign the first task to the second computer device that is operating normally to run through a distributed architecture.

### CROSS-REFERENCE TO RELATED APPLICATION

This application claims the priority benefit of Taiwan application serial no. 113119673, filed on May 28, 2024. The entirety of the above-mentioned patent application is hereby incorporated by reference herein and made a part of this specification.

### BACKGROUND

### Technical Field

The disclosure relates to an industrial control mechanism, and more particularly, to a system and a method for maintaining task operation continuity.

### Description of Related Art

There are many different equipment operating together on a production line. When the hardware on the equipment fails, it is only required to directly replace spare parts, and the production line may continue to get back to work immediately. However, a situation becomes complicated if a controller with software/hardware integration (e.g., an industrial control computer) fails.

In severe cases, a supplier may need to assist in reinstalling an operating system and industrial control software, and resetting functions of a machine, which may cause the production line to be shut down for a long time due to inability to successfully perform tasks (e.g., processing tasks), resulting in significant losses.

### SUMMARY

In view of this, the disclosure provides a system and a method for maintaining task operation continuity, which may be used to solve the above technical issues.

The embodiment of the disclosure provides a system for maintaining task operation continuity, including a server communicatively coupled to a first computer device and a second computer device. The server is configured to monitor an operating status of each of the first computer device and the second computer device, in which each of the first computer device and the second computer device is deployed with a first task on Docker, and the first task is assigned to the first computer device to run, and in response to determining that the first computer device cannot operate normally, assign the first task to the second computer device that is operating normally to run through a distributed architecture.

The embodiment of the disclosure provides a method for maintaining task operation continuity, including the following. An operating status of each of the first computer device and the second computer device is monitored by a server communicatively coupled to a first computer device and a second computer device. Each of the first computer device and the second computer device is at least deployed with a first task on Docker, and the first task is assigned to be run by the first computer device. In response to determining that the first computer device cannot operate normally, the first task is assigned, by the server, to the second computer device that is operating normally to run through a distributed architecture.

### BRIEF DESCRIPTION OF THE DRAWINGS

FIG. 1 is a schematic view of a system for maintaining task operation continuity according to an embodiment of the disclosure.

FIG. 2 is a schematic view of performing a backup task according to an embodiment of the disclosure.

FIG. 3 is a schematic view of restoring a computer device according to the embodiment of FIG. 2.

FIG. 4 is a flowchart of a method for maintaining task operation continuity according to an embodiment of the disclosure.

FIG. 5 is a flowchart of a method for maintaining task operation continuity according to another embodiment of the disclosure.

### DETAILED DESCRIPTION OF DISCLOSED EMBODIMENTS

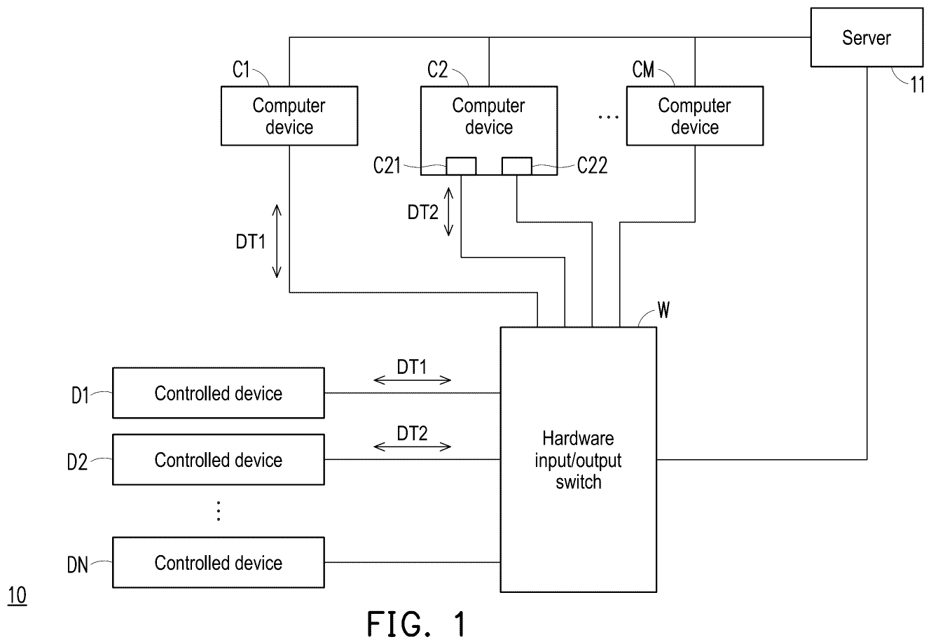

Referring to FIG. 1, FIG. 1 is a schematic view of a system for maintaining task operation continuity according to an embodiment of the disclosure.

In FIG. 1, a system 10 includes a server 11, computer devices C1 to CM (M is a positive integer), a hardware input/output switch W, and controlled devices D1 to DN (N is a positive integer). The server 11 is communicatively coupled to the computer devices C1 to CM and the hardware input/output switch W, and the hardware input/output switch W is communicatively coupled between the server 11, the computer devices C1 to CM, and the controlled devices D1 to DN.

In the embodiment of the disclosure, the server 11 is, for example, various smart devices and/or server devices, and may be used to manage the computer devices C1 to CM and/or the hardware input/output switch W. In the embodiment of the disclosure, the server 11 may include a storage circuit and a processor. The storage circuit is, for example, any type of fixed or removable random access memory (RAM), read-only memory (ROM), flash memory, hard disk, or other similar devices or a combination of these devices, and may be used to record multiple program codes or modules.

The processor is coupled to the storage circuit, and may be a general-purpose processor, a special-purpose processor, a conventional processor, a digital signal processor, multiple microprocessors, one or more microprocessors combined with a digital signal processor core, a controller, a microcontroller, an application specific integrated circuit (ASIC), a field programmable gate array (FPGA), any other types of integrated circuits, a state machine, a processor based on Advanced RISC machine (ARM), and a similar device.

In the embodiment of the disclosure, the processor may access the modules and the program codes recorded in the storage circuit to implement a method for maintaining task operation continuity provided in the disclosure.

In some embodiments, each of the computer devices C1 to CM may be an industrial control computer, and may be used to perform tasks assigned by the server 11. In FIG. 1, an assigned task (hereinafter referred to as T1) of the computer device C1 is, for example, to exchange/transmit data DT1 with the controlled device D1 (e.g., a robot arm), and then control the controlled device D1 to perform a corresponding action (e.g., an assembly operation). Similarly, an assigned task (hereinafter referred to as T2) of the computer device C2 is, for example, to exchange/transmit data DT2 with the controlled device D2 (e.g., a robot arm), and then control the controlled device D2 to perform a corresponding action (e.g., a labeling operation or a locking operation). In addition, other computer devices may also control the corresponding controlled devices in response to assigned tasks.

In an embodiment, the server 11 may monitor an operating status of each of the computer devices C1 to CM, such as whether each of the computer devices C1 to CM is operating normally. In different embodiments, when a computer device fails to perform the assigned tasks normally (for example, unable to boot, connection interrupted, etc.), the server 11 may determine that the computer device cannot operate normally, but the disclosure is not limited thereto.

In some embodiments, the server 11 may receive data and a status of a run task from each of the computer devices C1 to CM. For example, the computer device C1 in FIG. 1 can may upload data and a status of the run task T1 to the server 11, and the computer device C2 may also upload data and a status of the run task T2 to the server 11. However, the disclosure is not limited thereto.

In some embodiments, each of the computer devices C1 to CM itself may not store any data related to the assigned tasks, but the disclosure is not limited thereto.

In FIG. 1, the server 11 may control the hardware input/output switch W to implement data exchange between each of the computer devices C1 to CM and the corresponding controlled device. For example, in a scenario of FIG. 1, the server 11 may control the hardware input/output switch W to connect the computer device C1 to the corresponding controlled device D1, and control the hardware input/output switch W to connect the computer device C2 to the corresponding controlled device D1. However, the disclosure is not limited thereto.

In the embodiment of the disclosure, each of the computer devices C1 to CM may have a default port and a backup port. For ease of understanding, hereinafter, the computer device C2 is taken as an example for description.

In FIG. 1, the computer device C2 may have, for example, a default port C21 and (at least one) backup port C22. Each of the default port C21 and the backup port C22 is, for example, an Ethercat port, but the disclosure is not limited thereto. In this embodiment, the default port C21 may be used, for example, to exchange data related to the task T2 assigned to the computer device C2. In the above scenario, the default port C21 may, for example, be connected to the controlled device D2 through the hardware input/output switch W to exchange the data DT2 with the controlled device D2, but the disclosure is not limited thereto.

In addition, when the computer device C2 is assigned to perform the task originally performed by other computer devices, the backup port C22 may be used, for example, to exchange data for the tasks.

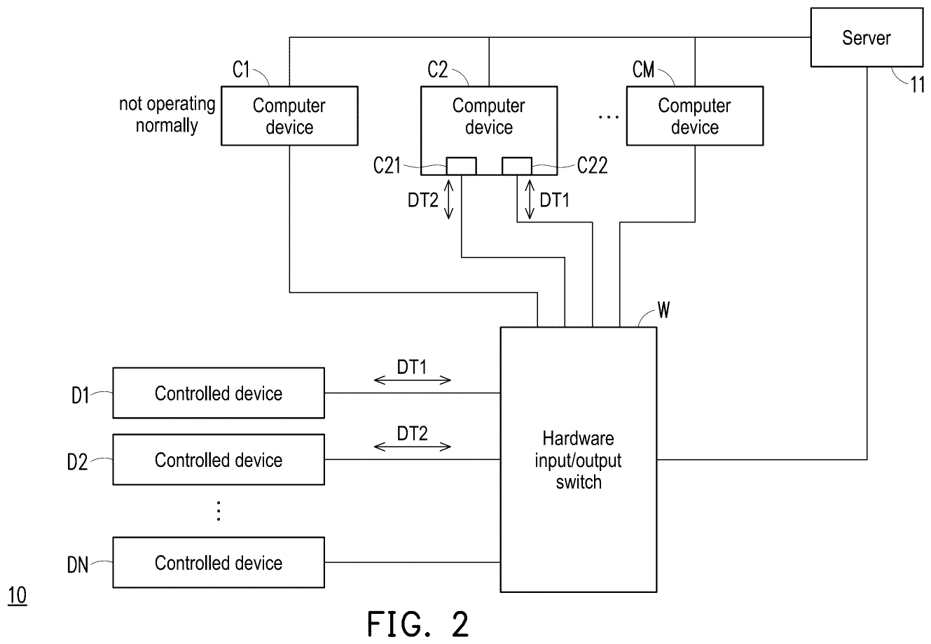

Referring to FIG. 2, FIG. 2 is a schematic view of performing a backup task according to an embodiment of the disclosure. In FIG. 2, it is assumed that computer device C1 cannot operate normally due to a fault or other reasons. In this case, the server 11 may assign the task T1 originally performed by the computer device C1 to the computer device C2 that is operating normally to be performed, and accordingly control the hardware input/output switch W to connect the backup port C22 of the computer device C2 to the controlled device D1. In this case, the computer device C2 may exchange the data DT1 related to the task T1 with the controlled device D1 through the backup port C22, and the computer device C2 in this case may be understood as being assigned to perform the backup task. However, the disclosure is not limited thereto.

In the above embodiment, when the computer device C1 cannot operate normally, the server 11 may, for example, assign the task T1 originally performed by the computer device C1 to the computer device C2 to be performed through a distributed architecture. In an embodiment, the distributed architecture is, for example, a 61499 distributed architecture, but the disclosure is not limited thereto.

Similarly, other computer devices may also be provided with the corresponding default port and the (at least one) backup port, and may operate according to a mechanism similar to the above teachings, and details thereof will not be repeated in the following.

In some embodiments, each of the computer devices C1 to CM may also be provided with one single port, and may exchange the data related to the assigned task (including the backup task) through the port, but the disclosure is not limited thereto.

In the above embodiment, in order to allow the computer device C2 to successfully perform the task T1 (which is originally assigned to the computer device C1 to be performed), the task T1 may be pre-deployed on the computer device C2. In addition, since the computer device C2 is assigned to perform the task T2, the task T2 is also required to be deployed on the computer device C2.

That is, in addition to the task T2 originally assigned to the computer device C2, the computer device C2 is also required to be deployed with the task T1 to facilitate the execution of the related backup tasks, but the disclosure is not limited thereto.

In the embodiment of the disclosure, the task deployed on each of the computer devices C1 to CM on Docker, for example. Specifically, the content of each of the tasks may be packaged into a Docker image file by using the relevant virtualization technology to package an environment and settings of industrial control software being run. In this way, the computer device may still obtain the same result when assigned to perform the backup task.

For example, since the computer device C2 has been pre-deployed with the task T1 (e.g., the Docker image file), when the computer device C2 is assigned to perform the corresponding backup task, the computer device C2 may achieve the same result as the computer device C1 when performing the task T1 (e.g., controlling the assembly operation performed by the controlled device D1).

In the embodiment of the disclosure, each of the computer devices C1 to CM may upload a device configuration thereof to the server 11 regularly or irregularly, and the server 11 may store the device configuration of each of the computer devices C1 to CM corresponding to different time points. However, the disclosure is not limited thereto.

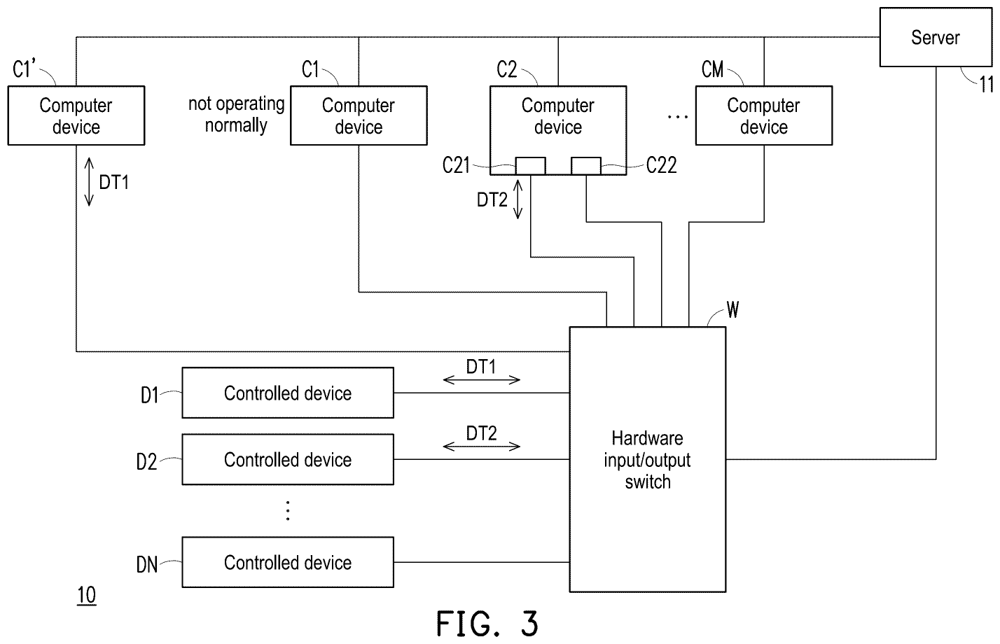

In some embodiments, when a certain computer device cannot operate normally, a maintenance personnel of the system 10 may, for example, connect a new computer device used to replace the computer device to the server 11. In this case, the server 11 may, for example, restore the new computer device based on the device configuration of the computer device that cannot operate normally, so that the new computer device has the same device configuration as the computer device that cannot operate normally. FIG. 3 will be used for further description below.

Referring to FIG. 3, FIG. 3 is a schematic view of restoring a computer device according to the embodiment of FIG. 2. In FIG. 3, it is assumed that the computer device C2 is exchanging the data related to the task T2 with the controlled device D2 through the default port C21, and is exchanging data related to the task T1 with the controlled device D1 through the backup port C22. That is, the computer device C2 is assigned to perform the task T1 in place of the computer device C1 that cannot operate normally.

In this case, assuming that a new computer device C1′ is connected to the server 11, the server 11 may restore the computer device C1′ to correspond to the computer device C1 according to the device configuration previously uploaded by the computer device C1 to the server 11.

In an embodiment, the computer device C1′ is, for example, a device running a FIDO device onboarding (FDO) protocol, and is configured with a script that restores the device configuration corresponding to the computer device C1. In this case, the server 11 may, for example, restore the computer device C1′ to correspond to the computer device C1 based on the FIDO device onboarding, so that the computer device C1′ has the same configuration as the computer device C1.

After the computer device C1′ is restored to have the same configuration as the computer device C1, the computer device C1′ will also be in a status of being deployed with the task T1. In this case, the server 11 may assign the task T1 run on the computer device C2 to the computer device C1′ to run through the distributed architecture (e.g., the 61499 distributed architecture).

In addition, the server 11 may control the hardware input/output switch W to connect the computer device C1′ (a default port thereof) to the controlled device D1. In this case, computer device C1′ may exchange the data DT1 related to the task T1 with the controlled device D1 (through the default port thereof).

That is, when the computer device C1′ used to replace computer device C1 is connected to the server 11, the server 11 may restore the device configuration of the computer device C1 on the computer device C1′. Afterwards, the server 11 may assign the task T1 performed by the computer device C2 to the computer device C1′, so that the computer device C1′ may continue to perform the task T1 (e.g., controlling the controlled device D1 to perform the assembly operation). However, the disclosure is not limited thereto.

In some embodiments, a connection between the computer device C1 and the server 11 may also be disconnected after the computer device C1 cannot operate normally (for example, the computer device C1 is removed from the system 10).

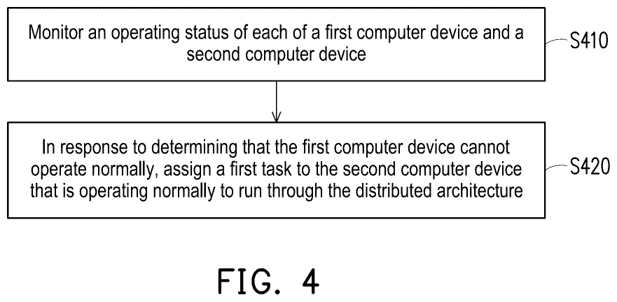

Referring to FIG. 4, FIG. 4 is a flowchart of a method for maintaining task operation continuity according to an embodiment of the disclosure. The method in this embodiment may be performed by the server 11 in FIGS. 1 to 3. Details of each of steps in FIG. 4 will be described below with reference to the elements shown in FIGS. 1 to 3.

In step S410, the server 11 monitors an operating status of each of a first computer device (e.g., the computer device C1) and a second computer device (e.g., the computer device C2). In step S420, in response to determining that the first computer device cannot operate normally, the server 11 assigns a first task (e.g., the task T1) to the second computer device that is operating normally to run through the distributed architecture (e.g., the 61499 distributed architecture).

For details of steps S410 and S420, reference may be made to relevant descriptions of the embodiments in FIGS. 1 to 3. Therefore, the same details will not be repeated in the following.

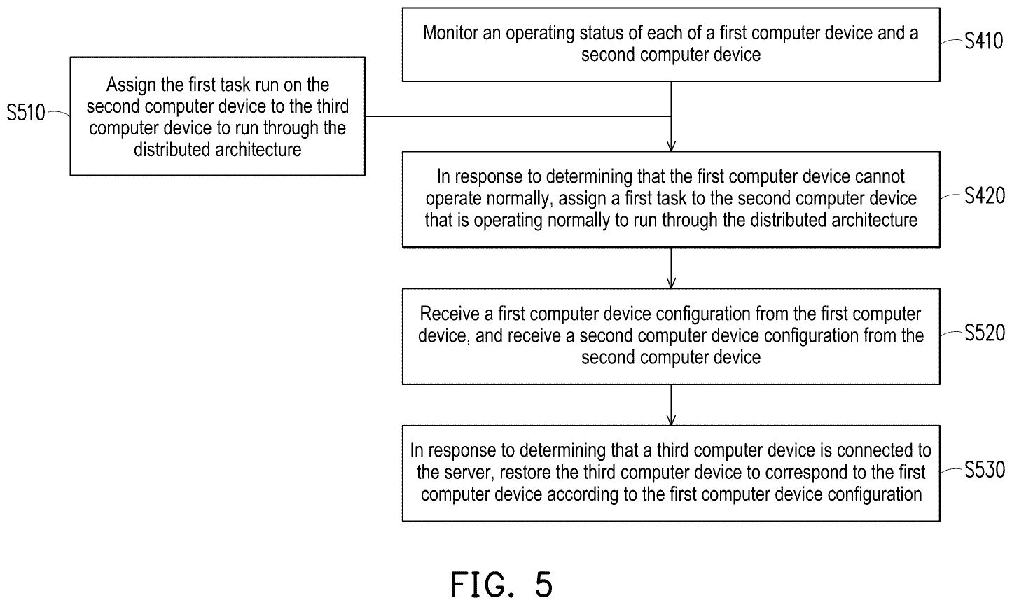

Referring to FIG. 5, FIG. 5 is a flowchart of a method for maintaining task operation continuity according to another embodiment of the disclosure.

In FIG. 5, in addition to steps S410 and S420 in FIG. 4, the server 11 may also perform step S510 to receive a first computer device configuration from the first computer device (e.g., the computer device C1) and receive a second computer device configuration from the second computer device (e.g., the computer device C2).

After step S420, in step S520, in response to determining that a third computer device (e.g., the computer device C1) is connected to the server 11, the server 11 restores the third computer device to correspond to the first computer device according to the first computer device configuration. Afterwards, in step S530, the server 11 assigns the first task run on the second computer device to the third computer device to run through the distributed architecture.

For details of steps S510, S520, and S530, reference may be made to the relevant descriptions of the embodiments in FIGS. 1 to 3. Therefore, the same details will not be repeated in the following.

Based on the above, when a certain computer device is unable to perform the assigned task due to failure, disaster, etc., in a technical solution in the embodiments of the disclosure, the task may be transferred to another computer device that is operating normally to continue running through the distributed architecture. In this way, the interruption of the task may be avoided, thereby achieving an effect of maintaining the task operation continuity.

In addition, when the new computer device comes online, in the technical solution in the embodiments of the disclosure, the device configuration of the failed computer device may be further restored on the new computer device based on the FDO protocol, and the above task is transferred back to the new computer device to be performed. In this way, data security of the task may be guaranteed due to features of a secure encryption channel and late binding provided by the FDO protocol.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A system for maintaining task operation continuity, comprising:
a server communicatively coupled to a first computer device and a second computer device and configured to:
monitor an operating status of each of the first computer device and the second computer device, wherein each of the first computer device and the second computer device is deployed with a first task on Docker, and the first task is assigned to the first computer device to run;
in response to determining that the first computer device cannot operate normally, assign the first task to the second computer device that is operating normally to run through a distributed architecture.

2. The system according to claim 1, wherein the distributed architecture comprises a 61499 distributed architecture.

3. The system according to claim 1, wherein the server receives data and a status of a run task from each of the first computer device and the second computer device.

4. The system according to claim 1, wherein the server is further configured to:
receive a first device configuration from the first computer device and receive a second device configuration from the second computer device;
in response to determining that a third computer device is connected to the server, restore the third computer device to correspond to the first computer device according to the first device configuration;
assign the first task run on the second computer device to the third computer device to run through the distributed architecture.

5. The system according to claim 4, further comprising the third computer device, wherein the third computer device is a device running a FIDO device onboarding protocol, and is configured with a script that restores the device configuration corresponding to the first computer device;
the server restores the third computer device to correspond to the first computer device based on the FIDO device onboarding protocol.

6. The system according to claim 1, further comprising the first computer device and the second computer device, wherein the first computer device and the second computer device are further deployed with a second task on Docker, and the second task is assigned to the second computer device to run;
wherein the second computer device has a default port and a backup port, the default port is used to transmit data associated with the second task, and after the second computer device is assigned to run the first task, the second computer device transmits data associated with the first task through the backup port.

7. The system according to claim 6, wherein each of the default port and the backup port of the second computer device is an Ethercat port.

8. The system according to claim 6, further comprising a hardware input/output switch coupled to the default port and the backup port of the second computer device and used to respectively transfer the data associated with the first task and the data associated with the second task to a corresponding first controlled device and a corresponding second controlled device.

9. The system according to claim 8, wherein after the first task run on the first computer device is assigned to the second computer device that is operating normally to run through the distributed architecture, the server controls the hardware input/output switch to exchange the data associated with the first task between the first controlled device and the backup port of the second computer device.

10. A method for maintaining task operation continuity, comprising:
monitoring, by a server communicatively coupled to a first computer device and a second computer device, an operating status of each of the first computer device and the second computer device, wherein each of the first computer device and the second computer device is at least deployed with a first task on Docker, and the first task is assigned to be run by the first computer device;
in response to determining that the first computer device cannot operate normally, assigning, by the server, the first task to the second computer device that is operating normally to run through a distributed architecture.
